(19) United States
(12) Patent Application Publication
(10) Pub. No.: US 2026/0116121 A1
(43) Pub. Date: Apr. 30, 2026

(54) LIGHT REACTIVE MATERIAL AND HOUSEHOLD ARTICLES MADE THEREFROM

(71) Applicant: InTexStyle LLC, Whitefish, MT (US)

(72) Inventor: Jing Lou, San Francisco, CA (US)

(21) Appl. No.: 19/371,406

(22) Filed: Oct. 28, 2025

Related U.S. Application Data
(60) Provisional application No. 63/714,322, filed on Oct. 31, 2024.

(51) Int. Cl. B44F 1/10; A47C 31/00; A47G 9/00

(52) U.S. Cl. CPC B44F 1/10; A47C 31/00; A47G 9/00; A47G 2009/005

(57) ABSTRACT

A household article includes a fabric material and a photochromatic or photoluminescent composition applied to the fabric material. The photochromatic or photoluminescent composition when dried on the fabric material can have a color or no discernible visual appearance when exposed to ambient lighting conditions, and exhibits a color change or a luminescence when exposed to a light source in selected light spectrum. A combination of a household article and a light source is also disclosed.

### CROSS-REFERENCE TO RELATED APPLICATION DATA

This application claims the benefit of and priority to Provisional U.S. Patent Application Ser. No. 63/714,322, filed Oct. 31, 2024, titled, LIGHT REACTIVE MATERIAL AND HOUSEHOLD ARTICLES MADE THEREFROM, the disclosure of which is incorporated herein in its entirety.

### BACKGROUND

The following description generally light reactive materials, such as light reactive fabrics and articles made from such materials.

Light reactive chemicals have a wide variety of uses. Such photochromic, chemiluminescent or photoluminescent compositions are used in novelty devices such as light sticks, signage, watches, and the like.

Permanent design features are also known. For example, design features on fabrics articles, such as clothing, for example, t-shirts, sweatshirts, pants, and the like are typically made using permanent markers, paints, dyes, and other colorants. Furniture fabrics designs are likewise dyed into the fabric. These compositions are, however, as the name implies, permanent.

Children often like to color or paint. As many parents know, small children might, accidentally or not, write, color, or otherwise apply markers or paints to items that should not be marked up or painted. Often the markings or paint cannot be fully removed, and marked or painted items may be ruined. Even if the marker or paint can be removed, the removal process may damage or weaken the underlying fabric, and there is often a shadow of the marker or paint that remains.

Accordingly, there is a need for a light reactive material and household articles made from such a material. Desirably, such a light reactive material is a fabric treated with a composition that may be a color or colorless under normal or ambient lighting conditions, but emits a visible change when subjected to certain other than normal or ambient lighting conditions. More desirably still such a material leaves no discernible visual impression when it is not activated by light.

### SUMMARY

According to an aspect, a household article incudes a fabric material and a photochromatic or photoluminescent composition applied to the fabric material. The photochromatic or photoluminescent composition when dried on the fabric material has a color or no discernible visual appearance when exposed to ambient lighting conditions, and exhibits a color or color change, or a luminescence when exposed to a light source in a selected light spectrum. One suitable light source is in the ultraviolet spectrum.

In embodiments, the photochromatic or photoluminescent composition is a photochromatic composition, and the photochromatic composition, if initially applied as a color, exhibits a color change, or if initially applied colorless, exhibits a color when exposed to the light source. The exhibited color can fade after a period of time. For example, the color can change or fade after about 2 seconds to about 100 seconds.

In other embodiments, the photochromatic or photoluminescent composition is a photoluminescent composition and the photoluminescent composition exhibits a luminescence when exposed to the light source. The exhibited luminescence can fade after a period of time. For example, luminescence can fade after about 10 minutes to about 12 hours.

The household article can be an item of furniture and the fabric can be applied to the furniture or can be a furniture cover. The fabric can also be a bed sheet, a pillow cover, a comforter or comforter cover, a duvet cover, a wall covering, or any other fabric item.

In another aspect, disclosed is a combination of a household article and a light source. The household article can include a fabric material and a photochromatic or photoluminescent composition applied to the fabric material. The photochromatic or photoluminescent composition when dried on the fabric material has a color or no discernible visual appearance when exposed to ambient lighting conditions, and exhibits a color or a color change, or luminescence when exposed to a light source in an ultraviolet light spectrum. The light source is an ultraviolet light source.

In such a combination, the photochromatic or photoluminescent composition can be a photochromatic composition, and the photochromatic composition exhibits a color or a color change when exposed to the light source. In some embodiments, the photochromatic or photoluminescent composition is a photoluminescent composition and the photoluminescent composition exhibits a luminescence when exposed to the ultraviolet light source.

In still another aspect, a method of entertainment includes providing a household article that comprises a fabric material and a photochromatic or photoluminescent composition applied to the fabric material, the photochromatic or photoluminescent composition when dried on the fabric material has a color or no discernible visual appearance when exposed to ambient lighting conditions. The method further includes providing an ultraviolet light source, and applying the ultraviolet light source to at least those areas of the fabric material having the photochromatic or photoluminescent composition to exhibit a color or a color change (if the composition is photochromatic) or to exhibit a luminescence (if the composition is photoluminescent).

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is an example of a children's play couch, the cover of which can have applied thereto a light reactive composition;

FIG. 2 is a screen shot of a fabric having a light reactive composition applied thereto and a color change of the fabric upon exposure to a light source; and

FIG. 3 is a screen shot of a fabric having another light reactive composition applied thereto and luminescence emitted upon exposure to a light source.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

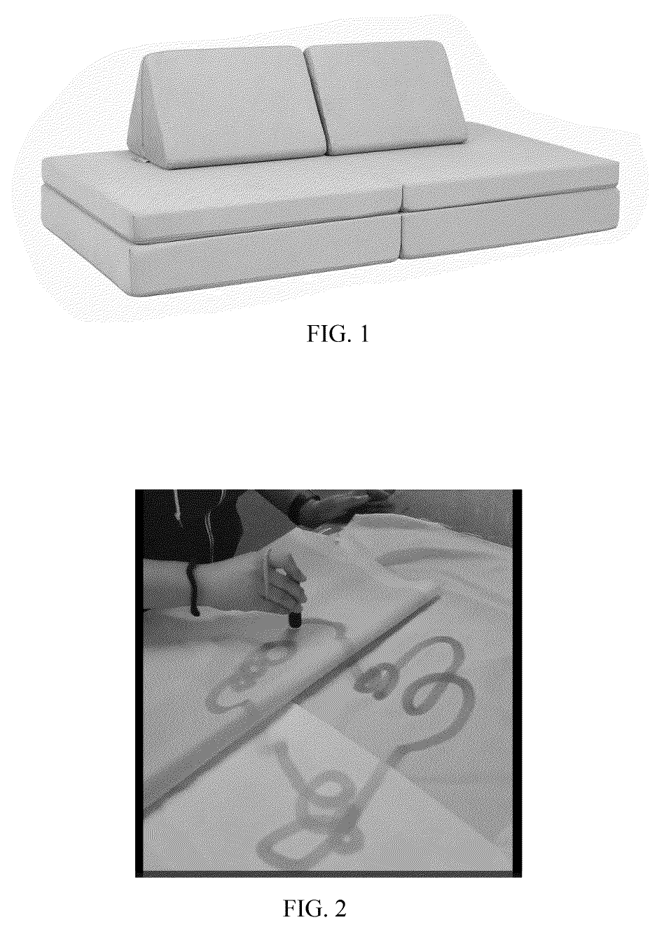

FIG. 1 illustrates an example of a children's play couch, the cover of which can have applied thereto a light reactive composition. FIG. 2 illustrates a material that has a photochromic composition applied to the material and the color changing effect when the material (the composition) is exposed to a light source. The illustrated material is a fabric having the light reactive composition applied to the entirety of the fabric material. The light reactive composition, such as a photochromic composition, has a color or has no color when dried after application. However, upon exposure to light of a certain frequency, such as a frequency in the ultraviolet wavelength range, e.g., about 40-100 nanometers (nm), the dried photochromic composition exhibits a color change if initially applied as a color, or illuminates in a color if it is initially applied having no color. One such color or color change is to purple, although other photochromic dyes/colorants can be used to create different colors.

In an embodiment, the color illumination will last for a relatively short period of time, and fades after, for example about two seconds to about 100 seconds. The time after which the color illumination fades or changes may be dependent on the type of photochromic composition (e.g., the chemical(s) used), the concentration of the composition and like characteristics.

In one embodiment, the photochromic colorant is Photochromic Slurry #81, New Purple BF Formaldehyde Free and has the following formulation:

| Constituent | Weight percent | CAS No. |
|---|---|---|
| Polyurethane | ~1-5% | 51852-81-4 |
| 6′-piperidino-1,3,3-trimethyl- | ~1-5% | 114747-45-4 |
| spiro[indolino-2,3′-[3H]napth-[2,1- | | |
| b][1,4]oxazine] | | |
| 1,1-bis(3,4-dimethylphenyl)ethane | ~30-40% | 1742-14-9 |
| Water | ~50-60% | 7732-18-5 |

### Table 1—Composition of Example Photochromic Material

Other suitable photochromic compositions will be recognized by those skilled in the art.

The photochromic composition can be applied to the entirety of the article fabric or on a portion of the article fabric. For example, the composition can be applied to the fabric on a surface of the article, or the composition can be applied in a pattern on the fabric surface.

In use, the fabric/surface having the composition applied thereto is exposed to a light source having a frequency in a specific range, for example, the ultraviolet range of about 40-100 nanometers (nm), and the area(s) exposed to the light source will exhibit a color change, which in the example above will be a purple color, as seen in FIG. 2. The exhibited color will last for a period of time, for example, about two seconds to about 100 seconds.

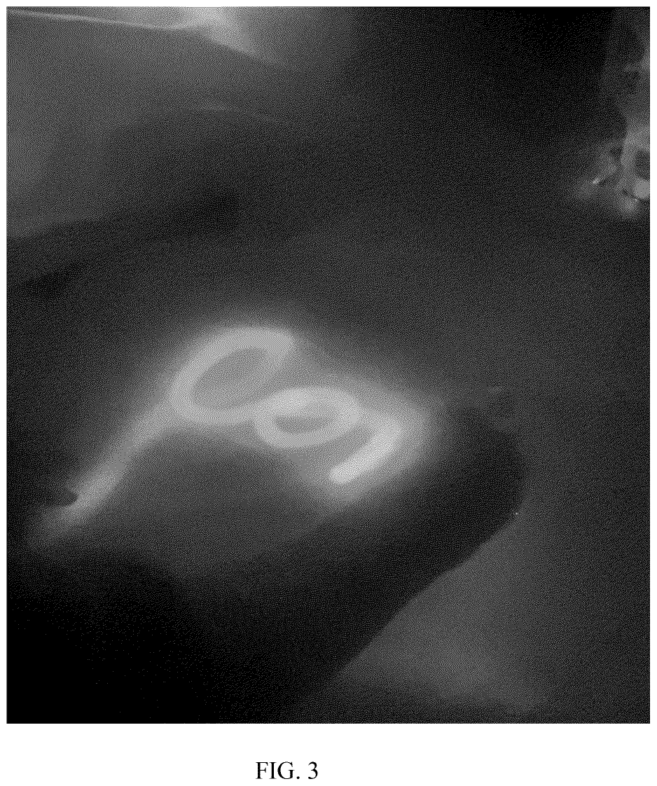

Other light reactive compositions can also be used. For example, photoluminescent compositions can be used in which upon exposure to a light source having a frequency in a specific range, for example, the ultraviolet range, and the area(s) exposed to the light source will emit light, e.g., illuminate or glow, for a period time, as seen in FIG. 3. Typically, the time period for such illumination is greater than the time period for color change, and may last as long a few minutes to hours, for example, the luminescence can last about 10 minutes to about 12 hours. The time after which the luminescence fades may be dependent on the type of photoluminescent composition (e.g., the chemical(s) used), the concentration of the composition and like characteristics.

It is envisioned that the composition can be applied to most any fabric, including cotton and cotton blends, synthetics such as polyester and polyester blends and other natural and synthetic materials.

In a preferred use, an ultraviolet light wand is used to expose the desired areas to the light source. Although any light source that emits light at least in part in the ultraviolet spectrum or range (such as a flashlight) can be used, a light wand that specifically emits light in the ultraviolet range is preferred.

There is a wide range of uses for such color changing or illuminating visual effects. For example, children may be entertained by having bedding in which they can doodle, write, draw and “color” during play time or during bed time. The composition, whether color changing or illuminating, can be applied to any fabric material. For example, the composition can be applied to bed sheets, pillow covers, comforters, duvet covers, wall coverings and the like. The composition can also be applied to fabric covered furniture, such as children's chairs, couches, and the like.

The composition can also be used for adult entertainment in a variety of ways. For example, a “mood” can be set by using the photochromic (color changing) or luminescent effect to direct one to a location within the home, or leave “hints” around the home.

Accordingly, a method of entertainment includes providing a household article that comprises a fabric material and a photochromatic or photoluminescent composition applied to the fabric material, the photochromatic or photoluminescent composition when dried on the fabric material has a color or no discernible visual appearance when exposed to ambient lighting conditions. The method further includes providing an ultraviolet light source, and applying the ultraviolet light source to at least those areas of the fabric material having the photochromatic or photoluminescent composition to, if the composition is photochromatic, exhibit a color change if initially applied as a color or to exhibit a color if initially applied as colorless, or if the composition is photoluminescent, to exhibit a luminescence.

It is understood that the features from any of the embodiments described herein may be combined with, or replace features of other embodiments described herein, without deviating from the scope of this disclosure.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A household article, comprising:
a fabric material; and
a photochromatic or photoluminescent composition applied to the fabric material,
wherein the photochromatic or photoluminescent composition when dried on the fabric material has a color or no discernible visual appearance when exposed to ambient lighting conditions, and
wherein the photochromatic or photoluminescent composition exhibits a color or a color change or a luminescence when exposed to a light source in selected light spectrum.

2. The household article of claim 1, wherein the light source is in an ultraviolet spectrum.

3. The household article of claim 2, wherein the photochromatic or photoluminescent composition is a photochromatic composition, and wherein the photochromatic composition exhibits a color or a color change when exposed to the light source.

4. The household article of claim 3, wherein the exhibited color or color change fades after a period of time.

5. The household article of claim 4, wherein the period of time is about 2 seconds to about 100 seconds.

6. The household article of claim 2, wherein the photochromatic or photoluminescent composition is a photoluminescent composition and wherein the photoluminescent composition exhibits a luminescence when exposed to the light source.

7. The household article of claim 6, wherein the exhibited luminescence fades after a period of time.

8. The household article of claim 7, wherein the period of time is about 10 minutes to about 12 hours.

9. The household article of claim 1, wherein the household article is an item of furniture and wherein the fabric is applied to the furniture.

10. The household article of claim 9, wherein the fabric is a cover for the furniture.

11. The household article of claim 1, wherein the fabric is a bed sheet, a pillow cover, a comforter or comforter cover, a duvet cover, or a wall covering.

12. In combination, a household article and a light source,
wherein the household article comprises a fabric material and a photochromatic or photoluminescent composition applied to the fabric material, wherein the photochromatic or photoluminescent composition when dried on the fabric material has a color or no discernible visual appearance when exposed to ambient lighting conditions, and wherein the photochromatic or photoluminescent composition exhibits a color or a color change or a luminescence when exposed to a light source in selected light spectrum, and
wherein the light source is an ultraviolet light source.

13. The combination of claim 12, wherein the photochromatic or photoluminescent composition is a photochromatic composition, and wherein the photochromatic composition exhibits a color or a color change when exposed to the light source.

14. The combination of claim 12, the photochromatic or photoluminescent composition is a photoluminescent composition and wherein the photoluminescent composition exhibits a luminescence when exposed to the light source.

15. A method of creating an entertaining visual appearance of a household article, comprising:
providing a household article that comprises a fabric material and a photochromatic or photoluminescent composition applied to the fabric material, the photochromatic or photoluminescent composition when dried on the fabric material has a color or no discernible visual appearance when exposed to ambient lighting conditions;
providing an ultraviolet light source; and
applying the ultraviolet light source to at least those areas of the fabric material having the photochromatic or photoluminescent composition to exhibit a color or color change if the composition is photochromatic or to exhibit a luminescence if the composition is photoluminescent.
